(19) United States
(12) Patent Application Publication
(10) Pub. No.: US 2013/0022466 A1
(43) Pub. Date: Jan. 24, 2013

(54) CONTROLLING OF A HEATING MAT ON A BLADE OF A WIND TURBINE

(71) Applicant: Hans Laurberg, Aarhus C. (DK)

(72) Inventor: Hans Laurberg, Aarhus C. (DK)

(21) Appl. No.: 13/639,195

(22) PCT Filed: Sep. 16, 2010
(86) PCT No.: PCT/EP10/63612

§ 371 Date: Oct. 4, 2012

(30) Foreign Application Priority Data
Apr. 12, 2010 (EP) 10159632.8
May 6, 2010 (EP) 10162190.2

(51) Int. Cl. F03D 11/00; H05B 3/02

(52) U.S. Cl. 416/95; 219/539

(57) ABSTRACT

The present invention describes a blade for a wind turbine. The blade includes a heating mat for generating heat by resistive heating, wherein the heating mat is mounted to the blade. The heating mat includes a first heating power emitting section for emitting a first heating power and a second heating power emitting section for emitting a second heating power. The heating mat is coupleable to a power supply unit for transferring power to the heating mat in such a way that the first heating power differs to the second heating power.

### FIELD OF INVENTION

The present invention relates to a blade for a wind turbine and a method of producing a blade of a wind turbine.

### ART BACKGROUND

Icing on any exposed part of a wind turbine can occur and cause decreased performance of the wind turbine. Furthermore e.g. when ice is accumulated on one or more of the rotor blades of a wind turbine, excess vibration problems from uneven blade icing may occur. This in turn may generate excessive mechanical loads on the wind turbine components leading eventually to wind turbine shut-down or to wind turbine faults.

Hence, it is necessary to avoid ice or to remove ice located on wind turbine blades by a deicing system or by a heating system. In particular, it is known to use an electrical heating that is attached to an outer surfaces of the blade.

In particular, there is also a need to heat the tip ends of the blades, so that in conventional heating systems a conductor has to run from the tip end to the root end of the blade. In particular, in the region of the tip end of the blade, the risk is severe that the conductor running to the heating being hit by a lightning strike.

Moreover, a conventional heating may comprise one common heating zone. Thus, if the heating extends over a large area of the blade surface, the complete area of the blade surface is heated, also if only a small part of the area is covered with ice, for example. Thus, a large area of the blade surface is heated also if there is only the need to heat a small area of the blade surface. Thus, the efficiency in conventional heating systems is reduced.

Moreover, when a large area of the blade is heated, the heat loss in blade sections that have not to be heated is generated. In particular during high wind speeds, such as wind speeds of ca. 300 km/h, the heat loss is very high. In order to heat only small fields along the blade surface, a pattern of small heating element is attachable to the blade surface. Each heating element has to be connected by respective conductors for receiving power in order to generate heat. Thus, an expensive wiring is necessary. Moreover, the heating elements in the tip end area of the blade have to be as well connected by a conductor running along the complete surface of the blade, so that the conductor is exposed to lightning strikes. Thus, the risk of damage caused by lightning strike is high.

### SUMMARY OF THE INVENTION

The object of the present invention is to provide an efficient control of a heating system along a wind turbine blade.

The object is solved by a blade for a wind turbine and by a method of producing a blade of a wind turbine.

According to a first aspect of the present invention, a blade for a wind turbine is presented. The blade comprises a heating mat for generating heat by resistive heating, wherein the heating mat is mounted to the blade, in particular at an outer surface of the blade. The heating mat comprises a first heating power emitting section for emitting a first heating power and a second heating power emitting section for emitting a second heating power. The heating mat is coupleable to a power supply unit for transferring power to the heating mat in such a way that the first heating power differs to the second heating power.

According to a further aspect of the present invention, a method of producing a blade of a wind turbine is presented. The method comprises the mounting of a heating mat for generating heat by resistive heating to the blade, in particular at an outer surface of the blade, wherein the heating mat comprises a first heating power emitting section with a first heating power and a second heating power emitting section with a second heating power. A power supply unit is coupled to the heating mat for supplying power to the heating mat in such a way that the first heating power in the first heating power emitting section differs to the second heating power in the second heating power emitting section.

The heating mat is generally formed as a flat stripe-shaped mat extending in a longitudinal direction. The longitudinal direction defines the direction between two end points of the heating mat (in particular the direction or distance between two end points parallel to a plane that is parallel to the blade surface) between which the length of the heating mat is defined. The height extends vertically (in particular parallel to a normal of the (plane of the) outer blade surface) form the outer surface of the heating mat, and the width of the heating mat is the distance from side to side, measuring across the heating mat at right angles to the length. The width is shorter than the length of the heating mat. The width may be approximately 25 cm (centimeter) to 1.50 m (meter), preferably approximately 55 cm. The length of the heating mat may be generally twice as much as the length of the blade. The heating mat may comprise a length of approximately 60 m to 200 m (meter), preferably 90 m. Accordingly, the blade may have a length of approximately 30 m to 100 m (meter). The height of the heating mat may be approximately 0.5 mm (Millimeter) cm to 1 cm (centimeter). Preferably, the heating mat comprises an area density of the fibers of approximately 400 g/m² to 800 g/m², in particular approximately 600 g/m² (grams per square meter). On opposed ends along the longitudinal (extending) direction, the first end section and the second end section are formed. To the first end section and the second end section a power input and/or a power output connection may be attached.

By the power terminals, a voltage of 100 V AC to 1000 V (Volt) AC is applicable. In a static condition of the blades or the wind turbine, a voltage of 400 V AC the heating mat may generate a temperature of approximately 10° C. (Celsius) and a voltage of 650 V AC to 750 V AC may generate a temperature of approximately 20° C. to 30° C. This may though vary in dependency of the chosen heating mat area density and heating mat area. In a working condition of the blades, it is desired to apply a voltage for generating a heat by the heating mat along the surface of the blade of approximately a temperature of 2° C. to 4° C. in order to have a proper de-icing effect.

By the present invention, the heating mat comprises different heating power emitting sections with different heating power. In particular, the first heating power differs with respect to the second heating power. The different heating powers are achievable by generating different electrical resistance in the first heating power emitting section and the second heating power emitting section. Furthermore, the different heating powers are achievable by a relocating of the first heating power emitting section and/or the second heating power emitting section within the heating mat by adjusting a power voltage input to the heating mat.

The first heating power emitting section and the second heating power emitting section define different sections along the heating mat. The heating power emitting sections may comprise different structural attributes (such as different dimensions, fibre density, etc.) and/or comprise different currents and different current densities (i.e. the electric current per unit area of a cross section of the heating mat). This has the technical effect, that for generating different heating powers, it is not necessary to install a plurality of heating elements at the blade surface and to connect each heating element by respective conductors for supplying power. By the present invention, the heating mat itself comprises at least two heating power emitting sections for applying a desired heat to predefined regions or sections of the heating mat. It is not necessary to connect the heating mat with conductors at each heating power emitting section.

Thus, the electrical wiring may be reduced, so that also the weight and the costs may be reduced. Moreover, due to the reduction of the wiring along the blade surface, the risk of getting hit by a lightning strike is reduced as well, so that a more robust heating system on the blade of a wind turbine is achieved.

According to a further exemplary embodiment, the blade further comprises a first power terminal located at the outer surface and a second power terminal located at the outer surface. The first power terminal is coupleable to a power supply unit for supplying a first power voltage and wherein the second power terminal is coupleable to the power supply unit for supplying a second power voltage. The heating mat further comprises a first coupling section coupled to the first power terminal and a second coupling section coupled to the second power terminal. The first power voltage and the second power voltage are adjustable in such a way that the first location of the first heating power emitting section and a second location of the second heating power emitting section along the heating mat is relocatable.

The first coupling section and the second coupling section are spaced from each other along the heating mat. For example, the first coupling section may be formed in a first end section of the heating mat and the second coupling section may be formed in a second end section of the heating mat, wherein the second end section is the opposed side of the first end section of the heating mat in a longitudinal direction of the heating mat.

The first power voltage and/or the second power voltage may be a positive power voltage or a negative power voltage, so that a path of the electrons is formed between the first coupling section and the second coupling section.

The first heating power emitting section may for example form the path for the electrons, in particular the path between both power terminals and coupling sections, for instance. Depending on the difference of the first and second power voltage and the position of the coupling sections (location of input of the power voltage into the heating mat), a specific, predefined and desired location of the first heating power emitting section and the second heating power emitting section is locatable.

According to a further exemplary embodiment, the blade further comprises a further power terminal located at the outer surface. The heating mat further comprises a further coupling section coupled to the further power terminal. The further power terminal is coupleable to the power supply unit for supplying a further power voltage. The further power voltage is adjustable in such a way that the first location of the first heating power emitting section and the second location of the second heating power emitting section is relocatable. The further coupling section comprises a distance to the first coupling section and the second coupling section. Hence, a voltage power may be induced to the heating mat at least at three different and spaced coupling sections at the heating mat. Hence, by varying the induce power voltage, the path of the electrons, i.e. the electron density, may be adjusted along the heating mat by varying the induced power voltage, so that the conductivity and thus, the location of the first heating power emitting section and the second heating power emitting section, is adjustable and relocatable. Thus, by the present exemplary embodiment of the invention a plurality of coupling sections, preferably four, may be provided by the heating mat, so that a plurality of different voltage powers at different coupling sections of the heating mat may be induced, wherein the coupling sections are spaced between each other. Thus, a desired heat emitting pattern of the heating mat is generatable. Thus, it is not necessary to connect a conductor at each section that should emit a higher heating power. By the present invention, a controlling of the path of electrons is provided, so that emission of the heating power at the heating power emitting section is concentrated and only a part of the heating mat, in particular the first or second heating power emitting section, may be heated.

Additionally or alternatively, the first coupling section, the second coupling section and/or the further coupling section may comprise a substantially zero electrical potential. For example, one of the coupling sections or power terminals may be connected to earth.

According to a further exemplary embodiment, the blade further comprises a control unit. The control unit is adapted for determining the first heating power and the second heating power on the basis of a power supply of the power supply unit and parameters defining the dimensions of the heating mat. For example, the control unit may calculate the heating power (e.g. by the formula P=R×I²). Additionally, in order to calculate the correct resistance of the heating mat, parameters for the dimension of the heating mat may be taken into account. The parameters may be e.g. the width of the heating mat. Moreover, the parameters may comprise the density of woven (carbon) fibres of the heating mat and/or the diameter of the single fibres of the heating mat.

According to a further exemplary embodiment, the control unit is further adapted for determining an icing of the blade on the basis of the determined first heating power, the determined second heating power, a measured wind speed, an ambient air temperature and/or an air humidity. The above-mentioned parameters may affect the icing on a surface of the blade. For example, higher air humidity leads to a fast icing on the outer blade surface than lower air humidity.

According to a further exemplary embodiment, the blade comprises a power transmitting section located on the outer surface of the blade, wherein the first power terminal and the second power terminal are located in the power transmitting section. The heating mat further comprises a first end section and the second end section, wherein the second end section defines an opposite end section of the heating mat in a longitudinal direction of the heating mat with respect to the first end section. The first end section comprises the first coupling section and the second end section comprises the second coupling section. The heating mat comprises a first mat section running from the first end section to a region being located outside of the power transmitting section. The heating mat further comprises a second mat section running from the region being located outside of the power transmitting section to the second end section inside the power transmitting section.

According to a further exemplary embodiment, the heating mat is mounted at an outer surface of the blade. The heating mat comprises a first section with a first end section and a second section with a second end section. The first end section and the second end section are electrically connectable (e.g. by a cable) to a respective power terminal for supplying power to the heating mat. The second end section defines an opposite end section of the heating mat in the longitudinal direction of the heating mat with respect to a first end section. The first section and the second section run along the surface of the blade in one or more loops from the first end section to the second end section.

In other words, the heating mat comprises a run parallel to the plane of the blade surface with e.g. a half-loop shape within a plane that is in general parallel to the plane of the blade surface. The heating mat runs from one power terminal (i.e. from the first coupling section) to the outside of the power transmitting section and after a half loop (e.g. a curve with approximately 180° degrees) the heating mat runs back from outside of the power transmitting section inside to the power transmitting section, where the second end section (i.e. the second coupling section) of the heating mat is finally connected to the second power terminal. The section of the heating mat that connects the first mat section and the second mat section outside of the power transmitting section is the transition section.

By the present exemplary embodiment, a blade is presented that comprises a heating mat that forms a half loop and/or a plurality of loops, wherein in one common power transmitting section the first end section and the second end section are connected to a power supply via the power terminals. Thus, the electrical connection and thus the sole necessary electrical wiring have to be applied at the power transmitting section and not in another section of the blade, such as the tip end section.

This has the technical effect, that no electrical connections, such as electrical wires, are needed to be mounted and connected along the blade surface except in the power transmitting section. Thus, less risk of damages to the heating mat due to lightning strikes or other physical impacts are reduced.

According to a further exemplary embodiment, the blade further comprises a root end section and a tip end section. The root end section comprises a fixing element for fixing the blade to a hub of the wind turbine, wherein the power trans-mitting section is formed within the root end section. The tip end section comprises a transition section which connects the first mat section and the second mat section in the region outside of the power transmitting section.

The fixing elements in the root end section are for instance fixing bolts for fixing a blade to a holder (hub) of the blades of the wind turbine. The root end section is located on the opposite side of the tip end of the blade with respect to a longitudinal direction of the blade. In particular, the root end section may describe the first half of the blade starting from the root end running along the longitudinal direction of the blade. In particular, the root end section may define one third, one fourth, one fifth of the blade section starting from the root end of the blade in longitudinal direction to the tip end. In particular, the root end section may define the section on the blade that extends from the root end approximately 1 m, 2 m, 5 m, 10 m or 20 m in the longitudinal direction to the tip end of the blade, for instance.

Thus, by locating the root end section close to the root end of the blade and by locating the power transmitting section in the root end section, the risk of damages by a lightning strike is reduced. In general, the likelihood that the blades getting hit by a lightning strike is higher in the area of the tip end section of the blade. Thus, the power connections of the heating mat at the first end section and the second end sections are located in the power transmitting section and thus in the root end section, so that a direct hit by a lightning strike at the tip end section does only hardly affect the connection of the end sections of the heating mat with the power terminals. Thus, the exemplary embodiment of the blade as described above is more robust, in particular in comparison to power connections or power connecting cables running along a blade for connecting a conventional heating mat at the section of the tip end of the blade.

The first mat section runs from the e.g. root end section of the blade, where the power transmitting section may be located, in longitudinal direction of the blade to the area of the tip end section, performs in the transition section e.g. a half loop or 1½ loops and runs with its second mat section back to the power transmitting section, wherein the second end section is connected to the second power terminal. Thus, there is no electrical connection to the heating mat between the root end and the tip end, so that lightning strikes that impact in the region of the tip end do not destroy the power connection to the heating mat, so that the general function of the heating mat is kept unaffected. In the transition section the heating mat may comprise a run that forms beside a half loop as well one or more full loops, so that a preferred pattern of the heating mat may be formed on the surface of the blade. Thus, an individually adjustable heating characteristic of the heating mat along the blade may be achieved.

According to a further exemplary embodiment, the first mat section and the second mat section are mounted to the outer surface in such a way that between the first mat section and the second mat section a distance between each other is kept. Thus, an insulation between the first end section and the second mat section is established simply by providing the distance. Thus, no undesired short circuit is generated, in particular outside of the transition section.

According to a further exemplary embodiment, the first mat section and the second mat section run in such a way that the first mat section and the second mat section at least partially overlap each other. If the first mat section and the second mat section overlap each other, more heat is generated in particular in the overlapping region of the first mat section and the second mat section. The first section and the second section may cross each other. Additionally or alternatively, the first mat section and the second mat section may run parallel with respect to each other and overlap each other partially or completely. Thus, the generated heat may be concentrated to a predetermined location on the outer surface of the blade.

According to a further exemplary embodiment, the blade further comprises an insulation layer, wherein the insulation layer is interposed between the first mat section and the second mat section. In order to prevent short circuits between the first mat section and the second mat section of the heating mat, an insulation layer may be interposed inside the distance and the first mat section and the second mat section, respectively. With other words, the insulation layer is filled in the distance between the first mat section and the second mat section of the heating mat.

According to a further exemplary embodiment, the heating mat comprises carbon fibres for generating heat. Carbon fibres are very robust, so that the risk of damage caused by a lightning strike may be reduced. Moreover, the carbon fibres of the heating mat may be flexibly woven and thus adapted to the requirements of the blade to be heated. For instance, it may be beneficial to provide a higher density of the woven carbon fibres along the leading edge of the blade, so that more heat is produced in this leading edge area. Furthermore, by amending the density of the fibres, the amount of fibres and/or the diameter of the fibres, the resistance of the heating mat is amendable. Alternatively or additionally, the heating mat may also be made of other conductive materials, such as metal, e.g. copper fibres, or conductive synthetic material.

According to a further exemplary embodiment, the first heating section comprises a higher electrical resistance than the second heating section. Thus, the first heating section with the higher electrical resistance generates more heat than the second heating section with less electrical resistance (P=I²×R). The difference in the electrical resistance between the first heating section and the second heating section may be achieved by amending the amount of fibres, amending the interweaving of the fibres in the heating mat or by amending the diameter of the fibres of the heating mat.

According to a further exemplary embodiment, the first heating section comprises smaller dimensions in comparison to the second heating section for generating the higher resistance. The smaller dimension (e.g. the width of the heating mat) leads to a higher density of the fibre. The smaller dimension may be achieved as well by reducing the amount of fibres, for example. Moreover, the smaller dimension may be achieved by reducing e.g. the diameter of each fibre. The smaller dimension of the first heating section may be applied at a section of the blade, where a higher temperature is needed for achieving a deicing. In particular, the first heating section with a smaller diameter may be applied to a leading edge of the blade, because the leading edge is critical regarding icing (chill-effect).

With the above-described invention, first and second heating power emitting sections for emitting heating power are described. The first and second heating power emitting sections may be located at desired sections along the heating mat, in particular by inputting different power voltages at spaced coupling sections to the heating mat. The desired location of the heating power emitting sections may be determined for example by a variation of the resistance of the electrical heating mat along the blade and/or by controlling the power voltage input at several spaced coupling sections of the heating mat. By coupling several (spaced) coupling sections to the power supply unit, different power voltages at each coupling section is input in the heating mat, so that the path of the electrons and thus the density of the electrons along the heating mat may be adjusted and individually directed according to the need of the heating locations.

For example, icing may occur in different sections of the blade. When icing on a small part of the blade is detected, the heat may be concentrated in this section by individually controlling each power voltage input at the respective coupling section. Moreover, along sections, where oftentimes icing occurs, such as at the leading edge of a blade, the heating mats may comprise a higher electrical resistance (e.g. by varying the dimensions at this area), so that a higher heating power emission is generatable. Thus, a more efficient and robust heating system for a blade is achieved.

Additionally, if installing all coupling sections of the heating mat in one common power transmitting section at the root end section of the blade, no electrical wires are needed to be mounted and connected along the blade, in particular at the region of the tip end of the blade, except in the root end part of the blade. In this way there is less risk of damage to the heating system due to lightning strikes.

On the other side, the heating efficiency is improved, because the generated heating power may be concentrated to sections of the heating mat that needs more heating power. For example, when the turbine is working, the relative wind speed at the blade may reach 300 km/h. If the ambient temperature is low, a lot of energy is needed to remove the ice. If the power per square meter is low it will take a long time for removing the ice from the blade and it will cost a lot of energy. The amount of power needed to deice a whole blade makes it pretty impossibly to get enough power to the blade. By the blade with the heating mat according to the above-described invention, only a section, for example the first heating power emitting section, is heated with a high first heating power until the ice is removed from the blade. In a subsequent step, the first heating power emitting section is relocated to another section of the heating mat, so that another ice from another section of the blade is removed. Thereby the required power is reduced and less energy is used by the de-icing system.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a blade with a heating mat with sections of varying the systems according to an exemplary embodiment of the present invention.

FIG. 2 shows a blade with a heating mat and a plurality of coupling sections according to an exemplary embodiment of the present invention.

FIG. 3-FIG. 6 show different locations of the heating power emitting sections of the heating mat according to an exemplary embodiment of the present invention.

FIG. 7-FIG. 9 show different layouts of the heating mat along the outer surface of the blade according to an exemplary embodiment of the present invention.

### DETAILED DESCRIPTION

The illustrations in the drawings are schematical. It is noted that in different figures, similar or identical elements are provided with the same reference signs.

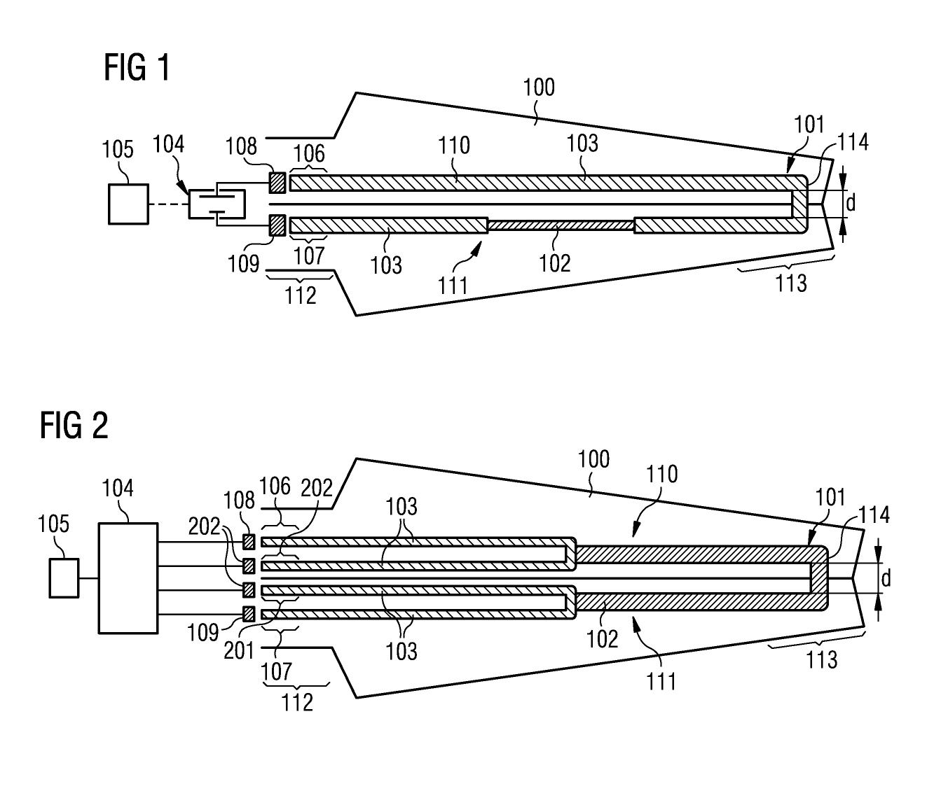

FIG. 1 shows a blade 100 for a wind turbine. The blade 100 comprises a heating mat 101 for generating heat by resistive heating. The heating mat 101 is mounted to the blade 100, in particular at an outer surface of the blade 100, wherein the heating mat 101 comprises a first heating power emitting section 102 for emitting a first heating power and a second heating power emitting section 103 for emitting a second heating power. The heating mat 101 is coupleable to a power supply unit 104 for transferring power to the heating mat 101 in such a way that the first heating power differs to the second heating power.

In the exemplary embodiment shown in FIG. 1, the first heating power emitting section 102 emits a higher first heating power in comparison to the second heating power emitting section 103 emitting the second heating power, so that with less energy or with a higher speed the ice on the outer surface of the blade may be removed. The first heating power emitting section 102 may be placed to critical sections of the blade, such as the leading edge.

The higher first heating power is caused by the higher resistance of the first heating power emitting section 102 in comparison to the second heating power emitting section 103.

For example, the first heating power emitting section 102 comprises a lower width than the second heating power emitting section 103. Thus, the resistance of the first heating power emitting section 102 is higher than the second heating power emitting section 103. In the exemplary embodiment of FIG. 1, the first heating power emitting section 102 and the second heating power emitting section 103 form different structural section of the heating mat 101.

In FIG. 1, the shell of the blade 100 is shown unfolded and open. In particular, the blade half above the symmetry line forms the upper side of a blade 100 and the other half below the symmetry line forms the underside of the blade 100.

Moreover, the heating mat 101 shown in FIG. 1 comprises a run with a half-loop. The run of the heating mat 101 runs from a root end section 112 of the blade 100 to a tip end section 113 of the blade 100. A first coupling section 106 of the blade 100 is coupled in the root end section 112 to a first power terminal. The heating mat 101 runs with a first mat section 110 from the root end section 112 to the direction of the tip end section 113. In the tip end section 113, a transition section 114 of the heating mat 101 is formed, wherein the first mat section 110 crosses over to a second mat section 111 by forming a half loop along the plane of the outer surface of the blade 100. The second mat section 111 runs from the tip end section 113 back to the second coupling section 107 which forms a second end section of the second mat section 111. The second coupling section 107, i.e. the second end section of the heating mat 101, is formed in the root end section 112. The second coupling section 107 is coupled to a second power terminal 109.

Thus, all electrical connections between the heating mat 101 and the power terminals 108, 109 and the power supply unit 104 are located at the root end section 112. Any electrical connections e.g. in the tip end section 113 to the heating mat 101 are not necessary, so that the risk of getting hit by a lightning strike is reduced.

The power supply unit 104 controls the input of the power voltage at the power terminals 108, 109. The amount of voltage power may also be controlled by the control unit 105. The power supply unit 104 and the control unit 105 may be located in a central part of the wind turbine. The power supply unit 104 and the control unit 105 may control and supply power voltage also to other blades of the wind turbine.

In order to prevent a short circuit between the first mat section 110 and the second mat section 111 a distance d between both sections 110, 111 is provided.

FIG. 2 illustrates a heating mat 101 located on the outer surface of the blade 100, wherein four coupling sections 106, 107, 201 of the heating mat 101 are shown. In the root end section 112 of the blade 100, the heating mat 101 comprises a first coupling section 106 coupled to the first power terminal 108, the second coupling section 107 coupled to the second power terminal 109 and two further coupling sections 201 coupled to further power terminals 202. The power terminals 108, 109, 202 are connected to the power supply unit 104 that is controlled for example by the control unit 105.

For example, the first heating power emitting section 102, which generates a higher heating power than the second heating power emitting section 103, may be formed in the tip end section 113 in order to remove ice on the outer surface of the blade 100. The second heating power emitting section 103 may be formed between the tip end section 113 and the root end section 112.

By generating four coupling sections 106, 107, 201 of the heating mat 101 a desired location of the first heating power emitting section 102 and the second heating power emitting section 103 in the heating mat 101 may be generated.

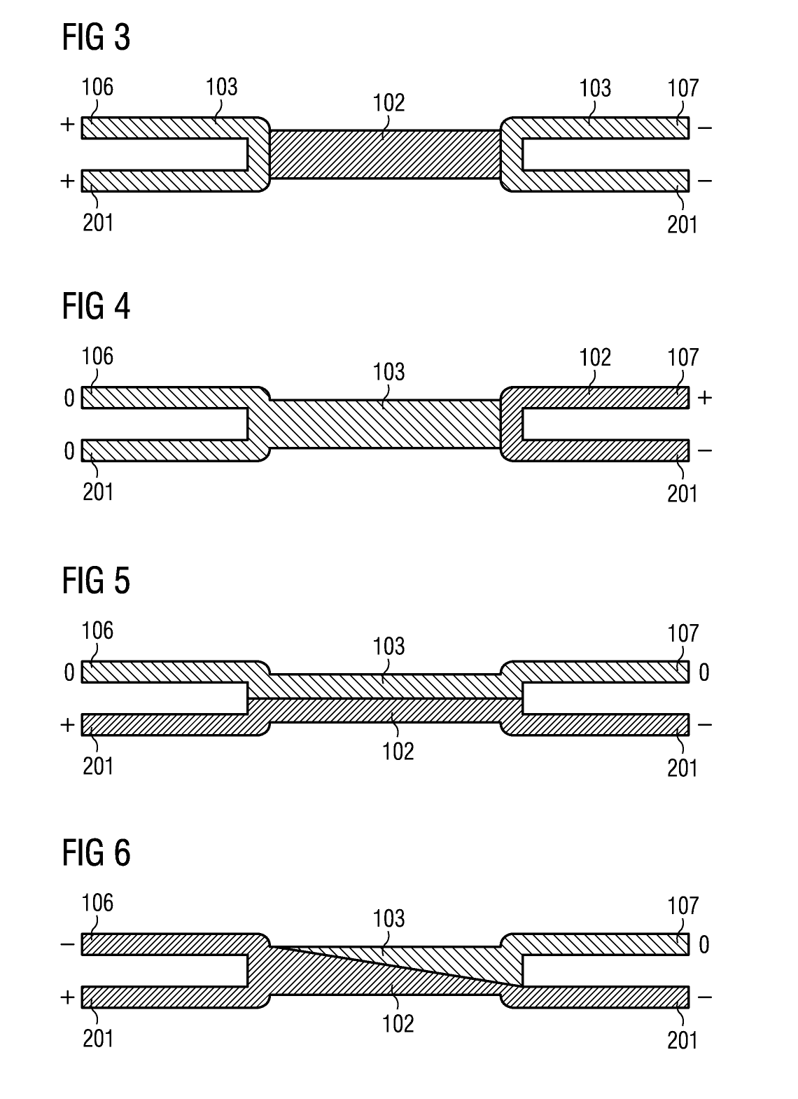

FIG. 3-FIG. 6 show examples, how different locations of the first heating power emitting sections 102 and second heating power emitting sections 103 may be formed on the heating mat 101. For the sake of clarity, FIG. 3-FIG. 6 shows the heating mat 101 in an unfolded status. In particular, the heating mat 101 is unfolded in such a way, that the run of the heating mat 101 does comprise a straight run without a half-loop shape, for example. In FIG. 3-FIG. 6, it is presumed, that the first heating power emitting section 102 has a higher first heating power than the second heating power emitting section 103.

FIG. 3 shows on the left side the first coupling section 106 and a further coupling section 201 and on the right side the second coupling section 107 and a further coupling section 201.

In FIG. 3, the central part of the heating mat 101 forms the first heating power emitting section 102. The left coupling sections 106, 201 comprise a positive power voltage input and on the right side the coupling sections 107, 201 comprise a negative power voltage input. Hence, the resistance of the heating mat is raised (e.g. by reducing the width of the fibre mat 101), so that the density of the electrons is concentrated in the middle section of the heating mat 101. Thus, a higher heating power is generated fin the middle section.

FIG. 4 shows an exemplary embodiment of the heating mat 101, wherein the first heating power emitting section 102 with the higher first heating power in comparison to the second heating power of the second heating power emitting section 103 is generated at the right part of the heating mat 101.

The second coupling section 107 receives a positive power voltage input and the further coupling section 201 on the right side of FIG. 4 receives a negative power voltage input. The first coupling section 106 and the further coupling section 201 on the left side of the heating mat 101 shown in FIG. 4 are connected to a zero potential. Hence, the path of the electrons and thus the density of the electrons is located on the right side of the heating mat 101 between the second coupling section 107 and the right further coupling section 201. In particular, the first coupling section 106 and the further coupling section 201 on the left side of the heating mat 101 shown in FIG. 4 may be connected to earth, for example.

FIG. 5 shows a further exemplary location of the first heating power emitting section 102. For example, to the left further coupling section 201 a positive voltage power input and to the right further coupling section 201 on the right side a negative power voltage input is connected. The first coupling section 106 and the second coupling section 107 are connected to a zero potential. Thus, the path of the electrons and the electron density runs between the further coupling sections 201. If folding the heating mat of FIG. 5 according to the heating mat 101 shown in FIG. 2, the first heating power emitting section 102 may be located closer to the leading edge or the trailing edge of the blade 100, for example.

FIG. 6 shows another location of the first heating power emitting section 102. To the first coupling section 106 and to the right further coupling section 201 a negative voltage power input is connected. To the further coupling section 201 on the left side of FIG. 6 a positive power voltage input is connected. To the second coupling section 107 a zero potential is connected. Thus, around the region of the second coupling section 107, the second heating power emitting section 103 emitting the second heating power is formed, wherein the second heating power is lower than the first heating power emitted by the first heating power emitting section 102. The first heating power emitting section 102 is generated between the other three coupling sections 106, 201.

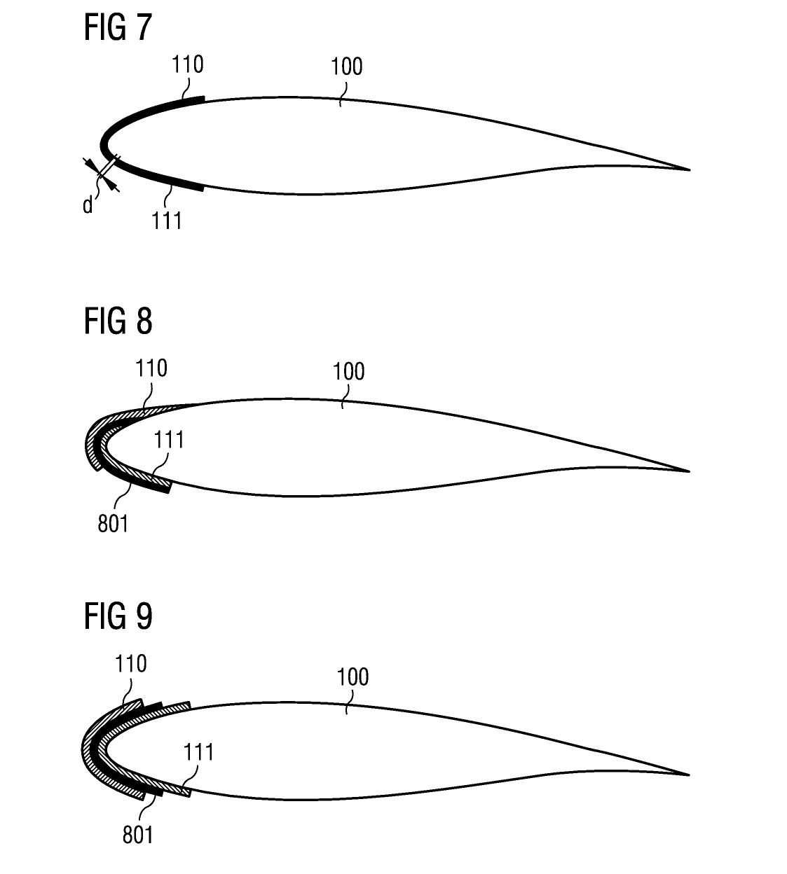

FIG. 7-FIG. 9 show different examples of certain runs of the heating mat 101 along the blade 100.

FIG. 7 illustrates a cross-sectional view of the blade 100, wherein the heating mat 101 is attached to the outer surface of the blade 100 in the area of the leading edge of the blade 100. The run of the heating mat 101 corresponds to the run of the heating mat 101 as can be taken from FIG. 1 or FIG. 2. As can be seen in FIG. 6, the first mat section 110 and the second mat section 111 are spaced apart by a predefined distance d in order to prevent a short circuitry.

FIG. 8 shows an exemplary embodiment with a further exemplary run of the heating mat 101. In FIG. 7, the first mat section 110 and the second mat section 111 of the heating mat overlap with each other. Thus, for example in the area of the leading edge of the blade 100, more heat may be generated, if the first mat section 110 and the second mat section 111 overlap each other at the leading edge. In order to prevent a short circuitry, an insulation layer 801 is interposed between the first mat section 110 and the second mat section 111. In FIG. 4, first mat section 110 and the second mat section 111 partially overlap.

FIG. 9 shows an exemplary embodiment, wherein the first mat section 110 completely overlaps the second mat section 111. Between the first mat section 110 and the second mat section 111 the insulation layer 801 is interposed.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

100 blade
101 heating mat
102 first heating power emitting section
103 second heating power emitting section
104 power supply unit
105 control unit
106 first coupling section
107 second coupling section
108 first power terminal
109 second power terminal
110 first mat section
111 second mat section
112 root end section
113 tip end section
114 transition section
201 further coupling section
202 further power terminal
801 insulation layer
d distance

1-14. (canceled)

15. A blade for a wind turbine, the blade comprising:
a heating mat mounted to the blade which generates heat by resistive heating, the heating mat comprising:
a first heating power emitting section for emitting a first heating power, and
a second heating power emitting section for emitting a second heating power,
wherein the heating mat is coupleable to a power supply unit for transferring power to the heating mat in such a way that the first heating power differs to the second heating power.

16. The blade according to claim 15, further comprising:
a first power terminal located at an outer surface of the blade; and
a second power terminal located at the outer surface,
the heating mat further comprising:
a first coupling section coupled to the first power terminal, and
a second coupling section coupled to the second power terminal,
wherein heating mat is coupleable to the power supply unit via the first power terminal and the second power terminal, and
wherein the first power voltage and the second power voltage are adjustable in such a way that a first location of the first heating power emitting section is relocatable and a second location of the second heating power emitting section along the heating mat is relocatable.

17. The blade according to claim 16, further comprising:
a further power terminal located at the outer surface,
the heating mat further comprising a further coupling section coupled to the further power terminal,
wherein the further power terminal is coupleable to the power supply unit for supplying a further power voltage, and
wherein the further power voltage is adjustable in such a way that the first location of the first heating power emitting section is relocatable and the second location of second heating power emitting section is relocatable.

18. The blade according to claim 16, further comprising:
a control unit adapted for determining the first heating power and the second heating power on the basis of a power supply of the power supply unit and parameters defining the dimensions of the heating mat.

19. The blade according to claim 18,
wherein the control unit is further adapted for determining an icing of the blade on the basis of the determined first heating power, the determined second heating power, a measured wind speed, an ambient air temperature and/or an air humidity.

20. The blade according to claim 16, further comprising:
a power transmitting section located on the outer surface of the blade, the first power terminal and the second power terminal are located in the power transmitting section, and
the heating mat further comprising:
a first end section includes the first coupling section,
a second end section, which defines an opposite end section of the heating mat in a longitudinal direction of the heating mat with respect to the first end section, includes the second coupling section,
a first mat section running from the first end section to a region being located outside of the power transmitting section, and
a second mat section running from the region being located outside of the power transmitting section to the second end section inside the power transmitting section.

21. The blade according to claim 20, further comprising:
a root end section with a fixing element for fixing the blade to a hub of the wind turbine; and
a tip end section,
wherein the power transmitting section is formed within the root end section, and
wherein the heating mat further comprising a transition section, which connects the first mat section and the second mat section in the region outside of the power transmitting section, is formed in the tip end section of the blade.

22. The blade according to claim 20,
wherein the first mat section and the second mat section are mounted to the outer surface so that a distance between the first mat section and the second mat section is kept between each other.

23. The blade according to claim 20,
wherein the first mat section and the second mat section are arrange so that the first mat section and the second mat section at least partially overlap each other.

24. The blade according to claim 20, further comprising:
an insulation layer which is interposed between the first mat section and the second mat section.

25. The blade according to claim 15,
wherein the heating mat comprising carbon fibres for generating heat.

26. The blade according to claim 15,
wherein the first heating power emitting section includes a higher electrical resistance than the second heating power emitting section.

27. The blade according to claim 15,
wherein the first heating power emitting section includes a smaller dimension in comparison to the second heating power emitting section for generating the higher resistance.

28. A method of producing a blade of a wind turbine, the method comprising:
mounting a heating mat according to claim 15,
coupling a power supply unit to the heating mat for supplying power to the heating mat in such a way that the first heating power in the first heating power emitting section differs to the second heating power in the second heating power emitting section.
